(19) United States
(12) Patent Application Publication
(10) Pub. No.: US 2011/0272900 A1
(43) Pub. Date: Nov. 10, 2011

(54) CENTRAL MULTIDIRECTIONAL DRIVE TRANSMISSION SYSTEM

(75) Inventor: Francisco Javier Lares, Sunland Park, NM (US)

(73) Assignee: Inicia IP Holdings, LLC.

(21) Appl. No.: 13/189,122

(22) Filed: Jul. 22, 2011

Related U.S. Application Data
(63) Continuation-in-part of application No. 12/824,798, filed on Jun. 28, 2010.
Application No. 12/824,798 is a continuation of application No. 11/439,799, filed on May 23, 2006, now Pat. No. 7,784,812.

(51) Int. Cl. B60G 17/015; B60G 7/00

(52) U.S. Cl. 280/5.513; 280/124.11

(57) ABSTRACT

A central multidirectional transmission system is disclosed which includes a chassis having a central base and a central multidirectional mechanism, a rear suspension assembly, and a front suspension assembly. The rear suspension assembly, the front suspension assembly, and one or more mechanical and structural components are mounted to the central base. The rear suspension assembly serves as a base for a rear suspension and a telescoping mechanism and is attached in a pivotal manner to the central base. The front suspension assembly is also mounted to the central base in a manner which permits the front suspension assembly to rotate at differing vertical and horizontal angles with respect to the longitudinal axis of the vehicle.

### CROSS-REFERENCE TO RELATED APPLICATIONS

This patent application is a Continuation-in-Part of U.S. patent application Ser. No. 12/824,798 entitled “Central Multi Directional Transmission System,” which was filed on Jun. 28, 2010, the disclosure of which is incorporated herein by reference in its entirety. U.S. patent application Ser. No. 12/824,798 claims priority as a continuation of U.S. patent application Ser. No. 11/439,799, which was filed on May 23, 3006, the disclosure of which is also incorporated herein by reference in its entirety.

### TECHNICAL HELD

Embodiments are generally related to all terrain vehicles. Embodiments are also related to vehicle drive transmission systems. Embodiments are additionally related to a multidirectional vehicle chassis assembly.

### BACKGROUND OF THE INVENTION

All-terrain vehicles (ATV's) such as, for example, haulage vehicle, high-mobility wheeled vehicle for transporting long loads over a road less terrain, a tractor, a rough terrain vehicle, a reconfigurable mobile vehicle, and an articulated tracked vehicle include a chassis assembly with a transmission system that works activating each of the vehicles mechanisms and gears with an electric motor. A body of the vehicle is typically supported on the chassis assembly which includes a frame, wheels, and an engine system. Majority of prior art chassis assemblies do not drive its force multi directionally and do not provide ample mobility and grip as required on a hard to reach terrain.

Based on the foregoing, it is believed that a need exists for an improved central multidirectional drive transmission system. A need also exits for an improved chassis assembly, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved central multidirectional drive transmission system that activates each mechanisms with an electric motor and/or a hydraulic injection motor.

It is another aspect of the disclosed embodiments to provide for an improved chassis assembly in order to drive force multi directionally with semi mechanisms that permits the vehicle's ample mobility and grip as required on a hard to reach terrain.

The aforementioned aspects and other objectives and advantages can now be achieved as described herein. A central multidirectional transmission system is disclosed which includes a chassis having a central base and a central multidirectional mechanism, a rear suspension assembly, and a front suspension assembly. The rear suspension assembly, the front suspension assembly, and one or more mechanical and structural components (e.g., engine, transmission, passenger seats, etc.) are mounted to the central base. The rear suspension assembly serves as a base for a rear suspension and a telescoping mechanism and is attached in a pivotal manner to the central base. The front suspension assembly is also mounted to the central base in a manner which permits the front suspension assembly to rotate at varying vertical and horizontal angles with respect to a longitudinal axis of the vehicle.

The front suspension assembly further includes an upper forward suspension bar, a lower forward suspension bar, and a torsional shaft which joins a front support with a front differential base. The front suspension assembly is attached to the center base via a four-arm system which are linked pivotally to the center base on one end and to the front support on the other end in order to permit a vertical displacement of the front suspension assembly with respect to the center base. The displacement may be commanded and controlled via an actuator system such as, for example, a servo motor, a hydraulic actuator, or a pneumatic actuator.

The front suspension assembly further includes a torsional shalt that is fixed to a front differential base and mounted to the front support with bearings to permit the assembly to rotate with respect to the longitudinal axis of the chassis. An axle runs through the center of the shaft and transmits the torque from the transmission to the front differential. The front differential base is held level with respect to the horizontal axis via the torsional shaft that is fixedly coupled with a gear. The gear is engaged by another gear, which is in turn fixedly coupled to a disc and held or released by a brake mounted to support. The brake is normally on so as to maintain the front suspension assembly level with the center base. The brake may be disengaged to permit the front suspension assembly to tilt clockwise or counterclockwise so that a free spinning tire can make contact with the ground and other solid object in order to achieve traction.

The rear suspension assembly includes a rear suspension mechanism mounted to the center base to permit the whole rear suspension assembly to rotate up and down with respect to the center base. The rear suspension mechanism includes a telescoping bar fixed to a rear differential base and may slip in and out of the rear suspension mechanism, effectively elongating the rear suspension assembly by a protrusion amount. The rear suspension mechanism is rotated downward to create a positive ventral space for additional ground clearance. The rear suspension mechanism may also be rotated upward if and when a negative ventral space is required. Additionally, the front suspension assembly may be raised or lowered independently or in conjunction with the rear suspension assembly to achieve any number of configurations as required to overcome an obstacle and to navigate a specific terrain.

The rear suspension mechanism further includes a shaft and a plate that fit inside a hollow cylinder and is free to rotate axially. A gear spins freely with respect to the shaft and is engaged by a worm mounted to the hollow cylinder. A torsion spring also fits inside the hollow cylinder and is attached to the plate at one end and to the gear at the other end. The worm is turned via an electric motor, hand crank, or any other suitable means which causes the gear to turn around the shaft. As one end of a torsion spring is held to the gear, turning the gear causes the coils of the spring to tighten or unwrap based on the direction of turn. Such an approach causes the rear suspension mechanism to rotate upward or downward (based on whether the tension in the spring is being increased or decreased) and maintains a level of torsional resistance (which in effect can constitute a secondary suspension mechanism).

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a side view of a central multidirectional transmission system and a chassis, in accordance with the disclosed embodiments;

FIG. 2 illustrates a top view of the chassis, in accordance with the disclosed embodiments;

FIGS. 3-4 illustrate a cut-away view of a front suspension assembly that controls degree of tilt with respect to a longitudinal axis of the vehicle, in accordance with the disclosed embodiments;

FIGS. 5-6 illustrate a detailed cut-away view of a rear suspension assembly, in accordance with the disclosed embodiments;

FIG. 7 illustrates a side view of the front and rear suspension assemblies aligned horizontally and a telescoping mechanism fully-open, in accordance with the disclosed embodiments;

FIG. 8 illustrates a detailed cut-away view of the rear suspension assembly with a minimum protrusion amount, in accordance with the disclosed embodiments;

FIG. 9 illustrates a lateral view showing a rear suspension mechanism rotated downward to create a positive ventral space for additional ground clearance, in accordance with the disclosed embodiments;

FIGS. 10-14 illustrate a side view of the front suspension assembly raised or lowered independently or in conjunction with the rear suspension assembly to overcome an obstacle and navigate a specific terrain, in accordance with the disclosed embodiments;

FIGS. 15-16 illustrate a detailed view of the central multidirectional transmission system that controls degree of tilt with respect to a longitudinal axis of the vehicle, in accordance with the disclosed embodiments;

FIG. 17 illustrates an exploded view of the central multidirectional transmission system, in accordance with the disclosed embodiments;

FIG. 18 illustrates an exploded view of the rear suspension mechanism and a torsion spring, worm, and gear arrangement, in accordance with the disclosed embodiments; and

FIG. 19 illustrates an exploded view of the rear suspension mechanism and the torsion spring, worm, and gear arrangement assembled inside a hollow cylinder portion of a center base, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

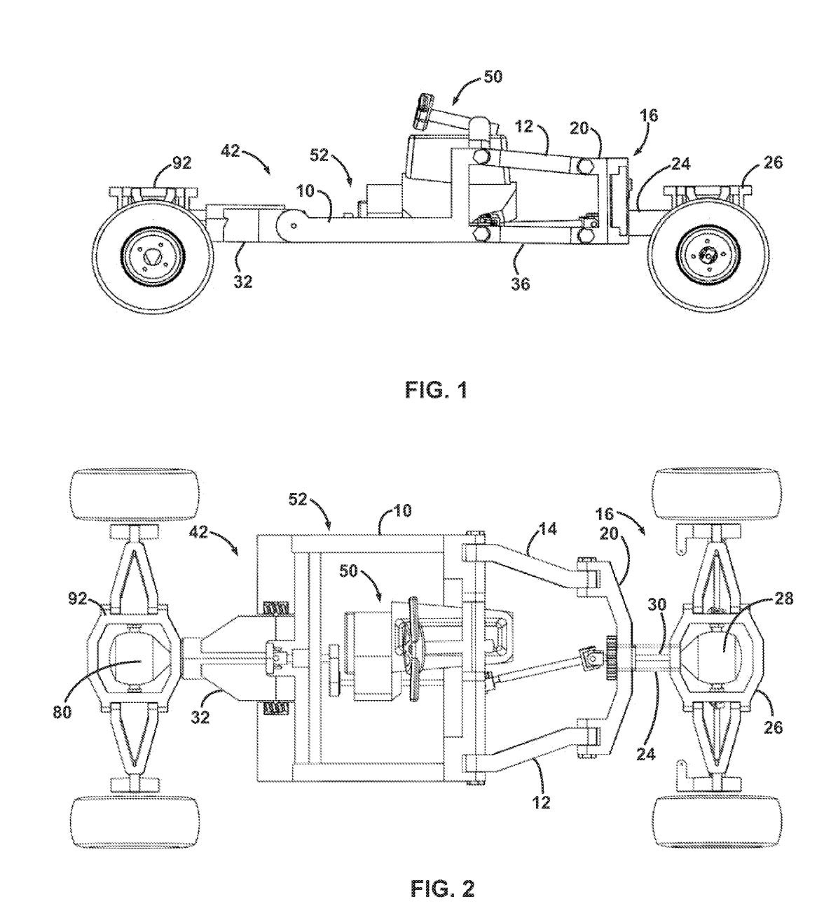

FIG. 1 illustrates a side view of a central multidirectional transmission system 50 and a chassis 52 of a vehicle, in accordance with the disclosed embodiments. The chassis 52 includes a central base 10, a rear suspension assembly 42, and a front suspension assembly 16. The rear suspension assembly 42, the front suspension assembly 16, and one or more mechanical and structural components (e.g., engine, transmission, passenger seats, etc.) can be mounted to the central base 10. The rear suspension assembly 42 serves as a base for a rear suspension and a telescoping mechanism, and the rear suspension assembly 42 is attached in a pivotal fashion to the central base 10. The front suspension assembly 16 is also mounted to the central base 10 in a manner which permits the front suspension assembly 16 to rotate at differing vertical and horizontal angles with respect to the longitudinal axis of the vehicle.

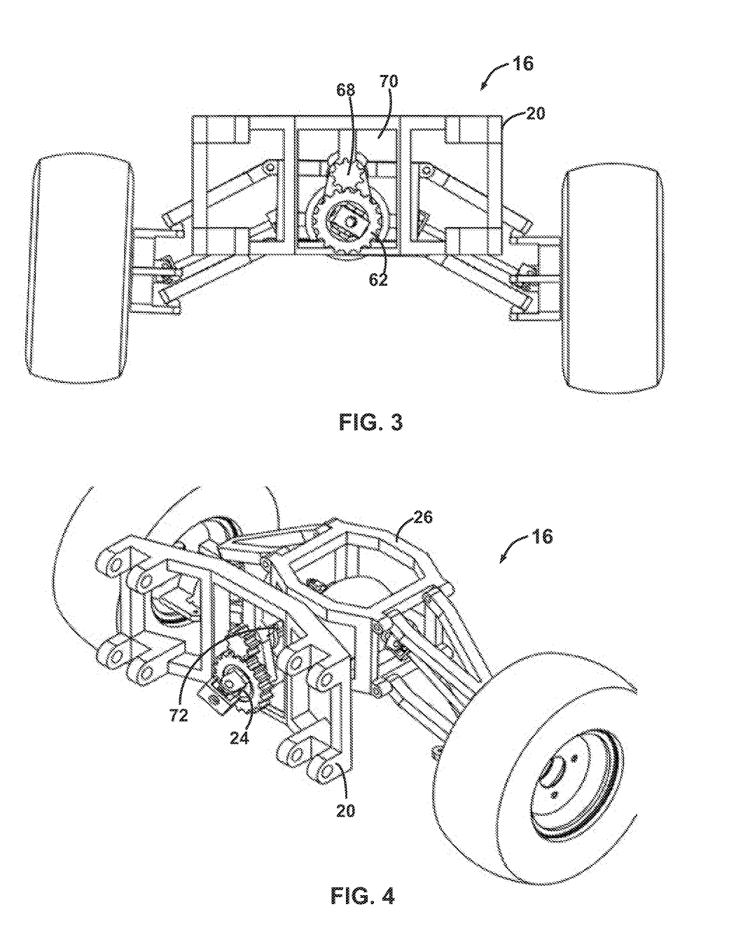

FIG. 2 illustrates a top view of the central multidirectional transmission system 50 and the chassis 52, in accordance with the disclosed embodiments. The front suspension assembly 16 further includes an upper forward suspension bar 12, a lower forward suspension bar 36, and a torsional shaft 24 which joins a front support 20 with a front differential base 26. The front suspension assembly 16 is attached to the center base 10 via a four-arm system (not shown). The four-arm system is linked pivotally to the center base 10 on one end and to the front support 20 on the other end in order to permit a vertical displacement of the front suspension assembly 16 with respect to the center base 10. The displacement may be commanded and controlled via any suitable actuator system such as, for example, a servo motor, a hydraulic actuator, or a pneumatic actuator.

The torsional shaft 24 is fixed to the front differential base 26 and mounted to the front support 20 with bearings or any other means to permit the front suspension assembly 16 to rotate with respect to the longitudinal axis of the chassis 52. An axle 30 runs through the center of the shaft 24 which transmits the torque from the transmission to a front differential 28. The rear suspension assembly 42 includes a rear suspension mechanism 32, a rear differential base 92, and a rear differential 80. The rear suspension mechanism 32 is mounted to the center base 10 such as to permit the whole rear suspension assembly 42 to rotate up and down with respect to the center base 10.

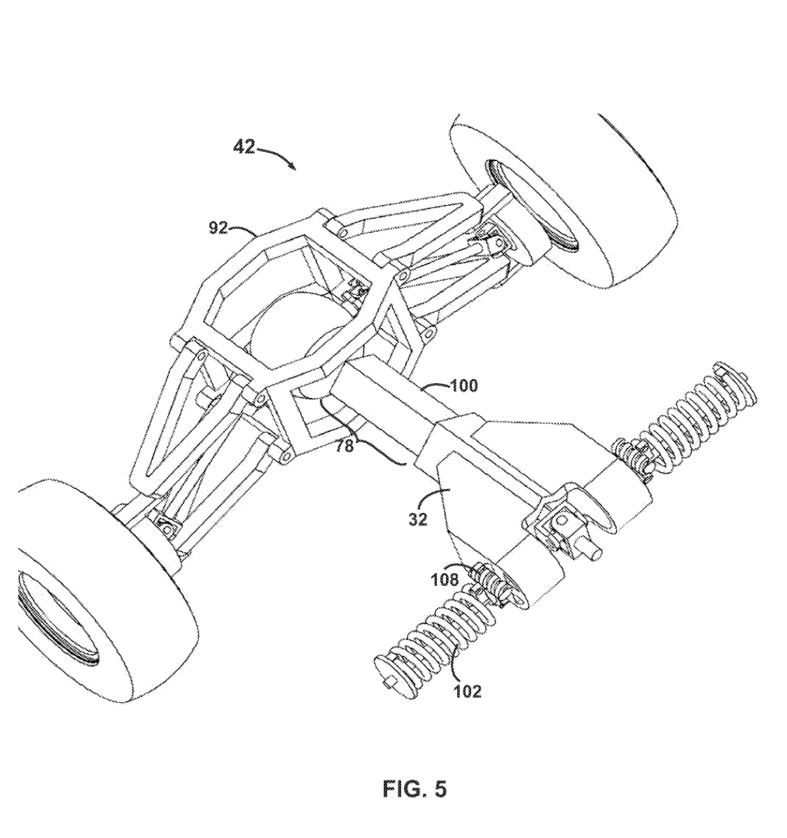

FIGS. 3-4 illustrate a cut-away view of the front suspension assembly 16 that controls degree of tilt with respect to a longitudinal axis of the vehicle, in accordance with the disclosed embodiments. The front differential base 26 is held level with respect to the horizontal via a disc-brake system. The torsional shaft 24 is fixedly coupled with a gear 62. The gear 62 is engaged by another gear 68, which is in turn fixedly coupled to a disc 72 which is either held or released by a brake 70 mounted to the support 20. The brake 70 is normally on so as to keep the front suspension assembly 16 level with the center base 10. Note that the brake 70 may be disengaged to permit the front suspension assembly 16 to tilt clockwise or counterclockwise so that a free spinning tire can make contact with the ground or other solid object in order to achieve traction. However, it will be apparent to those skilled in the art that the tilt action may be controlled in a passive manner, or in any number of active manners such as using servo motors, hydraulic/pneumatic actuators, etc., as desired without departing from the scope of the invention.

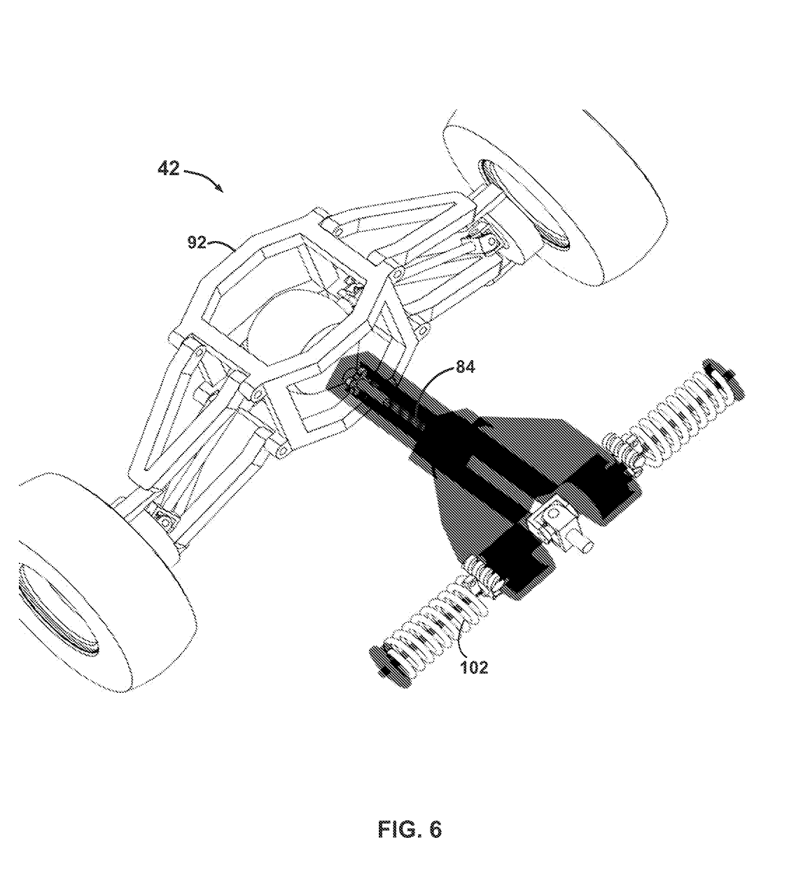

FIGS. 5-6 illustrate a detailed cut-away view of the rear suspension assembly 42, in accordance with the disclosed embodiments. The rear suspension assembly 42 further includes a rear suspension mechanism 32, a rear differential base 92, a telescoping bar 100, and a Cardan shaft 84. The telescoping bar 100 is fixed to the rear differential base 92 and may slip in and out of the rear suspension mechanism 32, effectively elongating the rear suspension assembly 42 by a protrusion amount 78. It should be understood that the amount of protrusion 78 may be controlled by any means, for example, a servo motor, hydraulic/pneumatic actuator, manual crank, etc., such that it may vary from a minimum amount (fully dosed position) to a maximum amount (fully open position). FIGS. 5-6 illustrate the torsion springs 102 coupled with a worm gear/spur gear arrangement 108 to illustrate one possible means by which the rear suspension assembly 42 may be lowered, raised, and provided with a degree of adjustable suspension resistance.

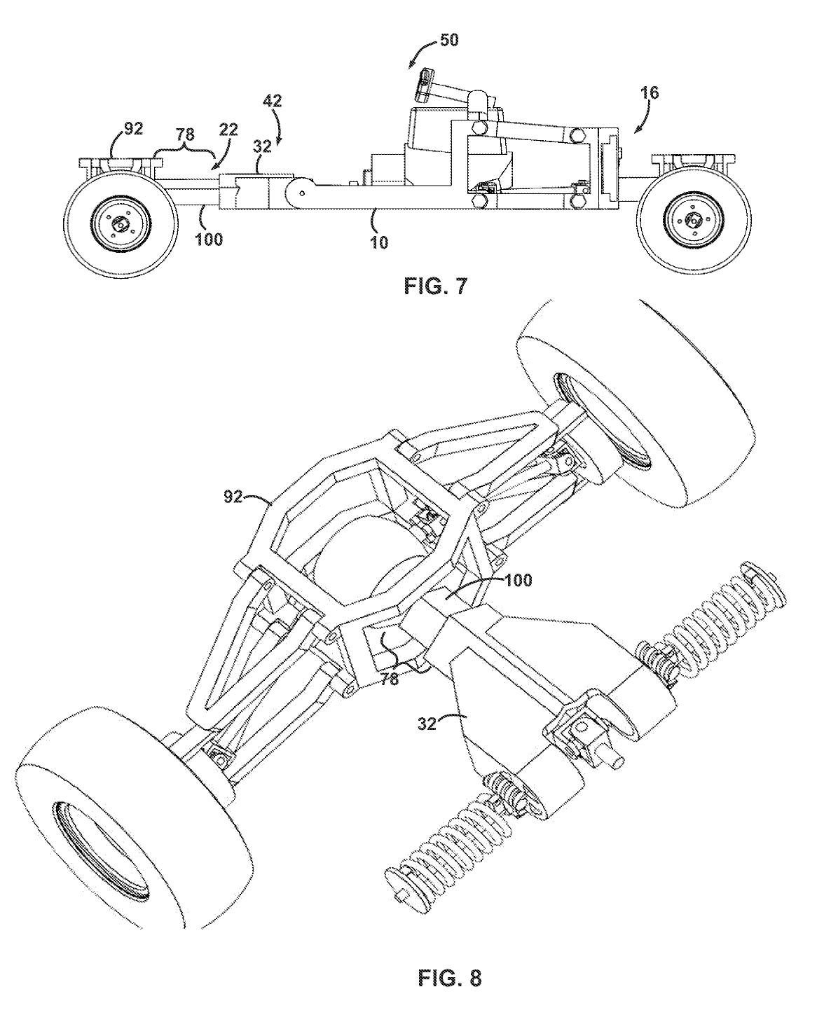

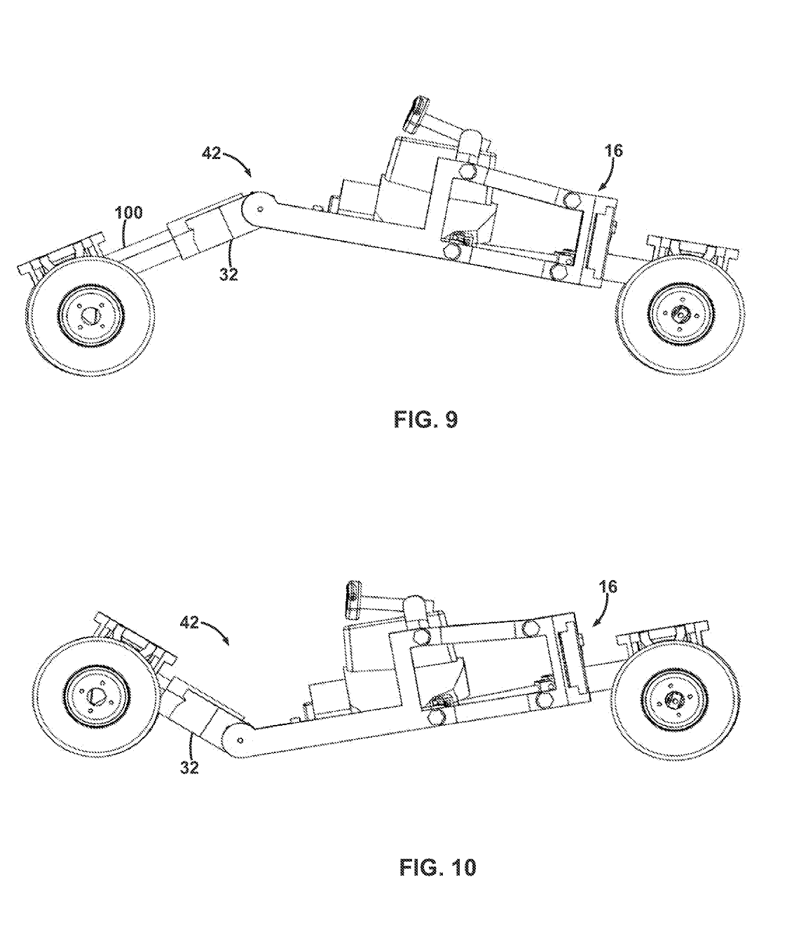

FIG. 7 illustrates a side view of the front and rear suspension assemblies 42 and 16 aligned horizontally and a telescoping mechanism 22 fully open, in accordance with the disclosed embodiments. FIG. 8 illustrates a detailed cut-away view of the rear suspension assembly 42 with a minimum protrusion amount 78, in accordance with the disclosed embodiments. The telescoping mechanism 22 is in a fully closed position.

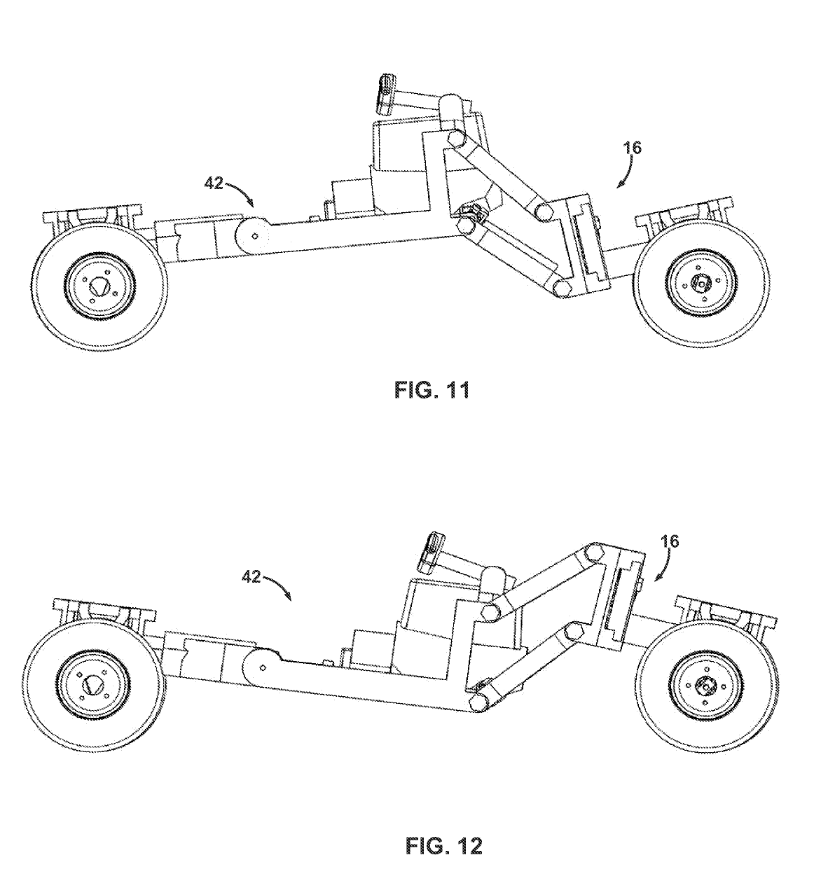

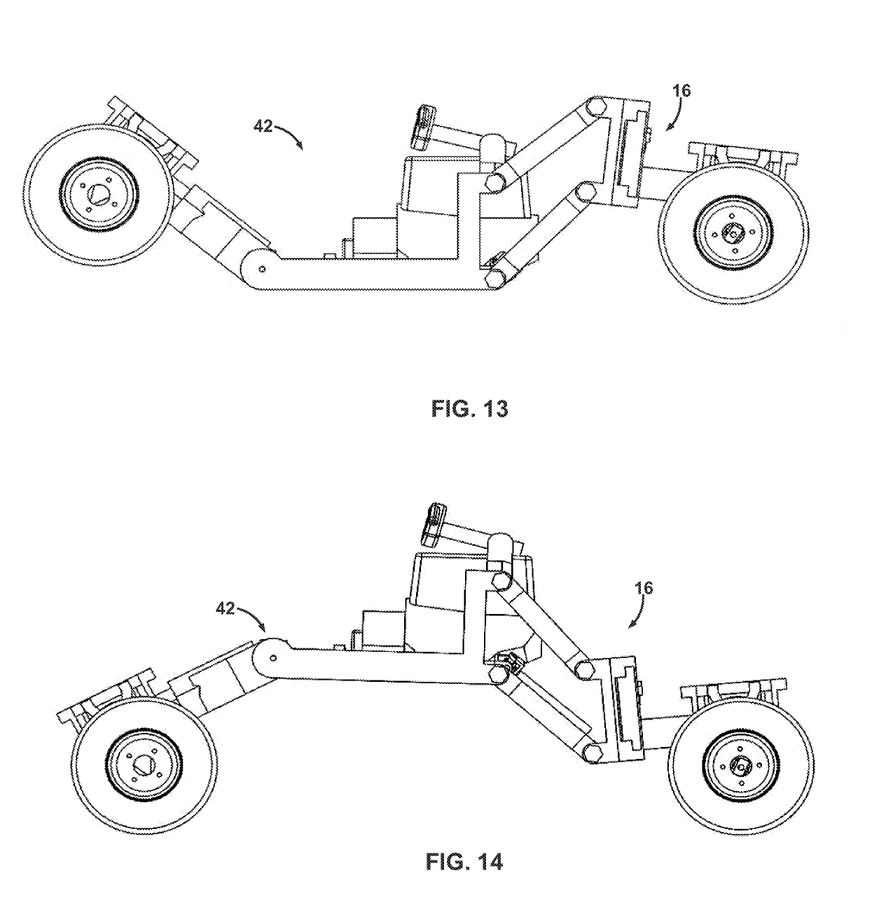

FIG. 9 illustrates a lateral view showing the rear suspension mechanism 32 rotated downward to create a positive ventral space for additional ground clearance, in accordance with the disclosed embodiments. The rear suspension mechanism 32 is rotated downward so as to create a positive ventral space for additional ground clearance, when needed. Even more ground clearance is achieved by extending the telescoping bar 100 to its full projection while in this position, as shown in FIG. 9. It should be understood that the rear suspension mechanism 32 may also be rotated upward if and when a negative ventral space is required as illustrated in FIG. 10. In addition, the front suspension assembly 16 may be raised or lowered independently or in conjunction with the rear suspension assembly 42 to achieve any number of configurations as required to overcome obstacles or navigate specific terrains, as shown in FIGS. 11-14.

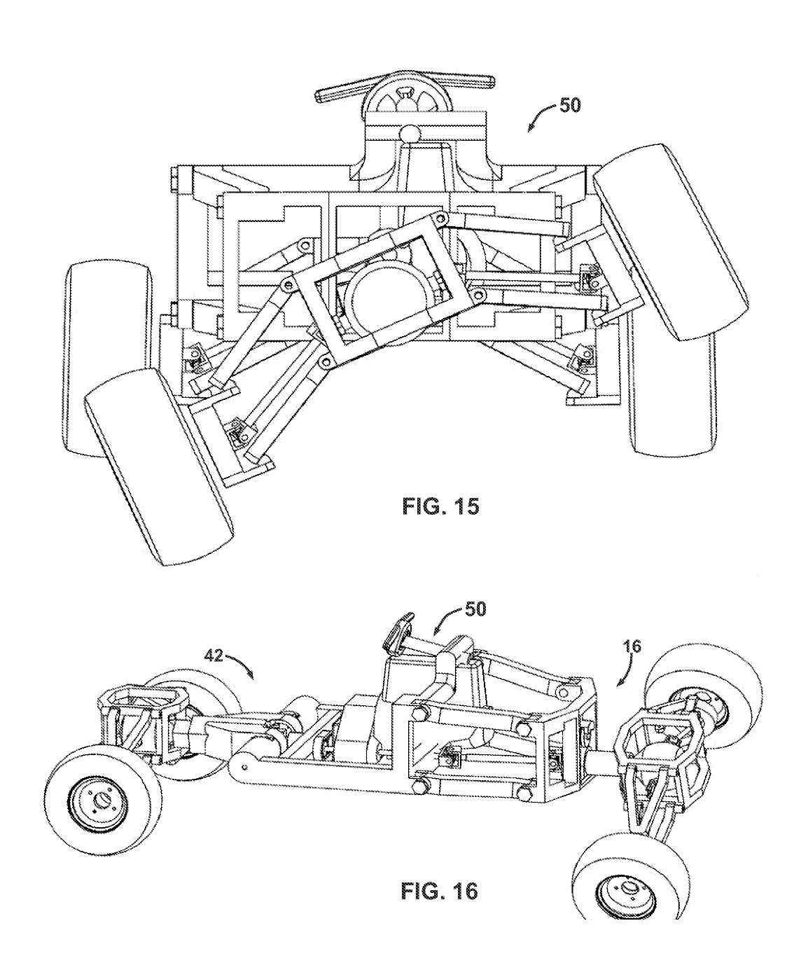

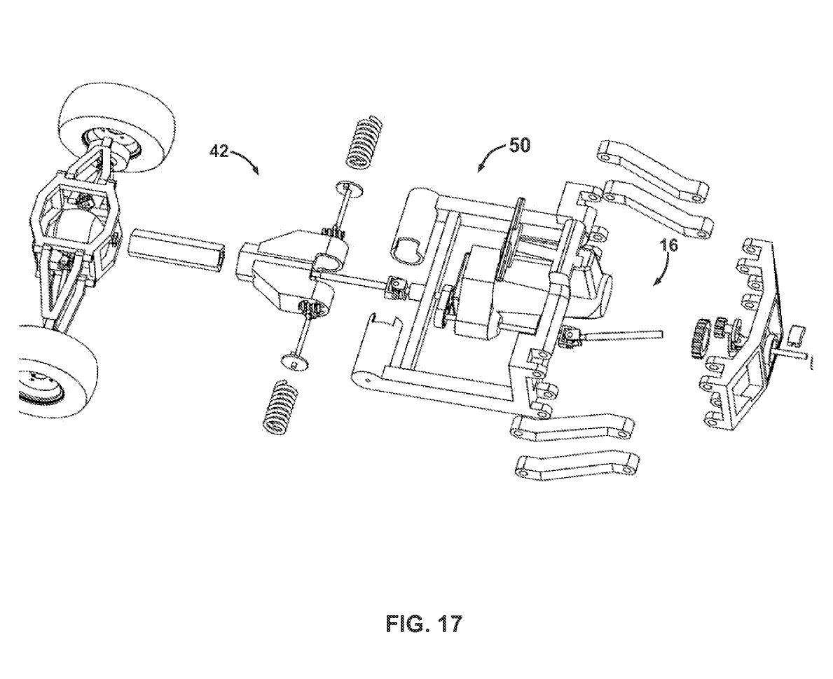

FIGS. 15-16 illustrate a detailed view of the central multidirectional transmission system 50 that controls degree of tilt with respect to a longitudinal axis of the vehicle, in accordance with the disclosed embodiments. FIG. 17 illustrates an exploded view of the central multidirectional transmission system 50, in accordance with the disclosed embodiments.

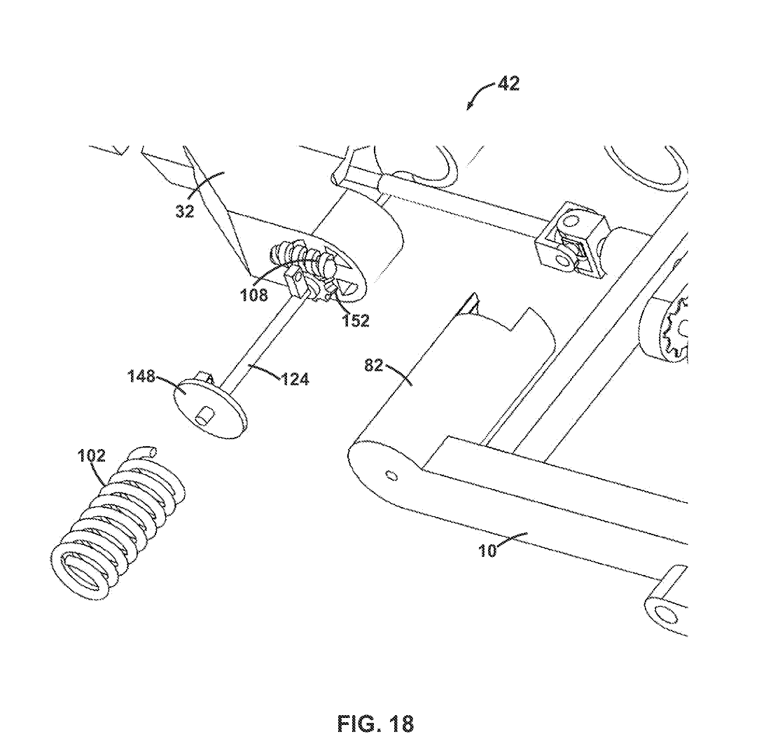

FIG. 18 illustrates an exploded view of the rear suspension mechanism 32 and the torsion spring, worm, and gear arrangement, in accordance with the disclosed embodiments. A shaft 124 and a plate 148 are fixed parts of the rear suspension mechanism 32 which fits inside the hollow cylinder 82 (which is part of center base 10) and are free to rotate axially inside it. Gear 152 spins freely with respect to the shaft 124, but is engaged by the worm 108 which is mounted to the hollow cylinder 82. Torsion spring 102 also fits inside the hollow cylinder 82 and is attached to the plate 148 at one end and to the gear 152 at the other (with the shaft 124 running inside its coil axis). It should be understood that the worm 108 is meant to be turned via an electric motor, hand crank, or any other suitable means.

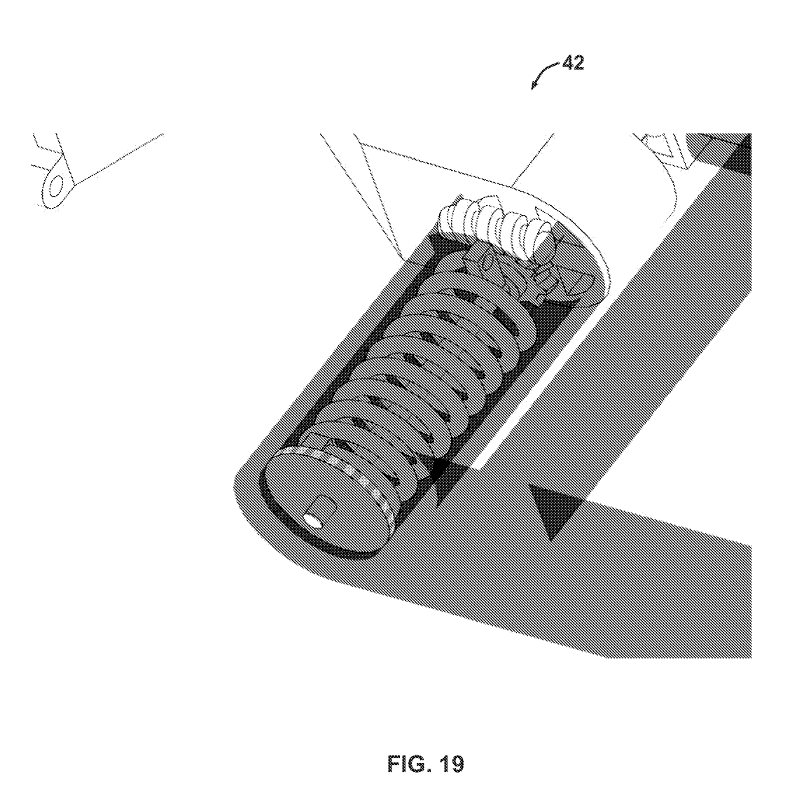

FIG. 19 illustrates an exploded view of the rear suspension mechanism 32 and the torsion spring, worm, and gear arrangement assembled inside a hollow cylinder portion 82 of the center base 10, in accordance with the disclosed embodiments. As the worm 108 is turned, it causes the gear 152 to turn around the shaft 124. As one end of the torsion spring 102 is held to the gear 152, turning the gear 152 causes the coils of spring 102 to tighten or unwrap, depending on the direction of turn. Such an approach causes the rear suspension mechanism 32 to rotate upward or downward (depending on whether the tension in spring 102 is being increased or decreased) and maintains a level of torsional resistance (which in effect would constitute a secondary suspension mechanism).

Based on the foregoing, it can be appreciated that a number of embodiments are disclosed. For example, in one embodiment a central multidirectional transmission system can include a chassis having a central base and a central multidirectional mechanism. Such a system can also include a rear suspension assembly serving as a base for a rear suspension and a telescoping mechanism the rear suspension assembly is attached in a pivotal manner to the central base. Additionally, such a system can also include a front suspension assembly mounted to the central base in a manner to rotate the front suspension assembly at a plurality of differing vertical and horizontal angles with respect to a longitudinal axis of a vehicle.

In another embodiment, the aforementioned front suspension can further include a four-arm unit for attaching the front suspension assembly to the center base, said four-arm unit is linked pivotally to said center base on one end and to a front support on the other end in order to permit a vertical displacement of the front suspension assembly with respect to the center base. In still another embodiment, the aforementioned front suspension assembly can further include an actuator device for commanding and controlling the displacement; an upper forward suspension bar and a lower forward suspension bar; a torsional shaft fixed to a front differential base and mounted to the front support with a bearing to permit the assembly to rotate with respect to the longitudinal axis of the chassis; an axle runs via a center of the torsional shaft and transmits torque from transmission to a front differential; and a gear fixedly coupled with the torsional shaft to hold the front differential base with respect to a horizontal axis.

In yet other embodiments, the aforementioned gear can be engaged by another gear which is in turn fixedly coupled to a disc, the disc is held or released by a brake mounted to a support. In still other embodiments, the aforementioned brake can be normally on so as to hold the front suspension assembly level with the center base. In other embodiments, the aforementioned brake can be disengaged to permit the front suspension assembly to tilt clockwise and counterclockwise and a free spinning tire to make contact with a ground and/or a solid object in order to achieve traction. In yet other embodiments, the aformentioned rear suspension assembly can further include a rear suspension mechanism mounted to the center base to permit the rear suspension assembly to rotate up and down with respect to the center base; and a rear differential base having a telescoping bar slip in and out of the rear suspension mechanism effectively elongating the rear suspension assembly by a protrusion amount.

In still other embodiments, the aforementioned rear suspension assembly further can include a fixed shaft and a plate of the rear suspension mechanism that fits inside a hollow cylinder and free to rotate axially inside the hollow cylinder; a gear spins freely with respect to the shaft and is engaged by a worm mounted to the hollow cylinder; and a torsion spring that fits inside the hollow cylinder and attached to a plate at one end and to the gear at other end wherein the gear is turned to tighten and unwrap a plurality of cons of the spring based on a direction of the turn in order to rotate the rear suspension mechanism upward and downward yet maintaining a level of torsional resistance.

In yet other embodiments, the aforementioned worm can be turned via an electric motor to turn the gear around the shaft. In other embodiments, the aforementioned rear suspension mechanism can be rotated downward to create a positive ventral space for an additional ground clearance and more ground clearance is achieved by extending the telescoping bar to a full projection. In still other embodiments, the aforementioned rear suspension mechanism can be rotated upward if a negative ventral space is required. In yet other embodiments, the aforementioned front suspension assembly can be raised and lowered independently and in conjunction with the rear suspension assembly to achieve a plurality of configurations to overcome an obstacle and to navigate a specific terrain.

In other embodiments, a central multidirectional transmission system can be implemented which includes a chassis having a central base and a central multidirectional mechanism, a rear suspension assembly serves as a base for a rear suspension, and a telescoping mechanism the rear suspension assembly is attached in a pivotal manner to the central base. Additionally, in such an embodiment, a front suspension assembly can be mounted to the central base in a manner to rotate the front suspension assembly at a plurality of differing vertical and horizontal angles with respect to a longitudinal axis of a vehicle, wherein the gear is engaged by another gear which is in turn fixedly coupled to a disc, the disc is held or released by a brake mounted to a support.

In still other embodiments, the aforementioned front suspension assembly can further include a four-arm unit for attaching the front suspension assembly to the center base, the four-arm unit is linked pivotally to the center base on one end and to a front support on the other end in order to permit a vertical displacement of the front suspension assembly with respect to the center base. In still other embodiments, the aforementioned front suspension assembly can further include an actuator device for commanding and controlling the displacement; an upper forward suspension bar and a lower forward suspension bar; a torsional shaft fixed to a front differential base and mounted to the front support with a bearing to permit the assembly to rotate with respect to the longitudinal axis of the chassis; an axle runs via a center of the torsional shaft and transmits torque from transmission to a front differential; and a gear fixedly coupled with the torsional shaft to hold the front differential base with respect to a horizontal axis.

In yet other embodiments, the aforementioned brake can be normally on so as to hold the front suspension assembly level with the center base. In still other embodiments, such a brake can be disengaged to permit the front suspension assembly to tilt clockwise and counterclockwise and a free spinning tire to make contact with a ground and/or a solid object in order to achieve traction.

In yet another embodiment, a central multidirectional transmission system can include a chassis having a central base and a central multidirectional mechanism; a rear suspension assembly serving as a base for a rear suspension and a telescoping mechanism the rear suspension assembly is attached in a pivotal manner to the central base, and a front suspension assembly mounted to the central base in a manner to rotate the front suspension assembly at a plurality of differing vertical and horizontal angles with respect to a longitudinal axis of a vehicle, wherein the front suspension assembly is raised and lowered independently and in conjunction with the rear suspension assembly to achieve a plurality of configurations to overcome an obstacle and to navigate a specific terrain.

In other embodiments, the aforementioned rear suspension assembly can further include a rear suspension mechanism mounted to the center base to permit the rear suspension assembly to rotate up and down with respect to the center base; and a rear differential base having a telescoping bar slip in and out of the rear suspension mechanism effectively elongating the rear suspension assembly by a protrusion amount.

In yet other embodiments, the aforementioned rear suspension assembly can further include a fixed shaft and a plate of the rear suspension mechanism that fits inside a hollow cylinder and free to rotate axially inside the hollow cylinder; a gear that spins freely with respect to the shaft and is engaged by a worm mounted to the hollow cylinder; and a torsion spring that fits inside the hollow cylinder and attached to a plate at one end and to the gear at other end wherein the gear is turned to tighten and unwrap a plurality of coils of the spring based on a direction of the turn in order to rotate the rear suspension mechanism upward and downward yet maintaining a level of torsional resistance.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A central multidirectional transmission system, comprising:
a chassis having a central base and a central multidirectional mechanism;
a rear suspension assembly serving as a base for a rear suspension and a telescoping mechanism said rear suspension assembly is attached in a pivotal manner to said central base, and
a front suspension assembly mounted to said central base in a manner to rotate said front suspension assembly at a plurality of differing vertical and horizontal angles with respect to a longitudinal axis of a vehicle.

2. The system of claim 1 wherein said front suspension assembly further comprises:
a four-arm unit for attaching said front suspension assembly to said center base, said four-arm unit is linked pivotally to said center base on one end and to a front support on the other end in order to permit a vertical displacement of said front suspension assembly with respect to said center base.

3. The system of claim 1 wherein said front suspension assembly further comprises:
an actuator device for commanding and controlling said displacement;
an upper forward suspension bar and a lower forward suspension bar;
a torsional shaft fixed to a front differential base and mounted to said front support with a bearing to permit said assembly to rotate with respect to said longitudinal axis of said chassis;
an axle runs via a center of said torsional shaft and transmits torque from transmission to a front differential; and
a gear fixedly coupled with said torsional shaft to hold said front differential base with respect to a horizontal axis.

4. The system of claim 3 wherein said gear is engaged by another gear which is in turn fixedly coupled to a disc, said disc is held or released by a brake mounted to a support.

5. The system of claim 3 wherein said brake is normally on so as to hold said front suspension assembly level with said center base.

6. The system of claim 3 wherein said brake is disengaged to permit said front suspension assembly to tilt clockwise and counterclockwise and a free spinning tire to make contact with a ground and/or a solid object in order to achieve traction.

7. The system of claim 1 wherein said rear suspension assembly further comprises:
a rear suspension mechanism mounted to said center base to permit said rear suspension assembly to rotate up and down with respect to said center base; and
a rear differential base having a telescoping bar slip in and out of said rear suspension mechanism effectively elongating said rear suspension assembly by a protrusion amount.

8. The system of claim 1 wherein said rear suspension assembly further comprises:
a fixed shaft and a plate of said rear suspension mechanism that fits inside a hollow cylinder and is free to rotate axially inside said hollow cylinder;
a gear that spins freely with respect to said shaft and is engaged by a worm mounted to said hollow cylinder; and
a torsion spring that fits inside said hollow cylinder and attached to a plate at one end and to said gear at other end wherein said gear is turned to tighten and unwrap a plurality of coils of said spring based on a direction of said turn in order to rotate said rear suspension mechanism upward and downward yet maintaining a level of torsional resistance.

9. The system of claim 8 wherein said worm is turned via an electric motor to turn said gear around said shaft.

10. The system of claim 8 wherein said rear suspension mechanism is rotated downward to create a positive ventral space for an additional ground clearance and more ground clearance is achieved by extending said telescoping bar to a full projection.

11. The system of claim 7 wherein said rear suspension mechanism is rotated upward if a negative ventral space is required.

12. The system of claim 1 wherein said front suspension assembly is raised and lowered independently and in conjunction with said rear suspension assembly to achieve a plurality of configurations to overcome an obstacle and to navigate a specific terrain.

13. A central multidirectional transmission system, comprising:
a chassis having a central base and a central multidirectional mechanism;
a rear suspension assembly serving as a base for a rear suspension and a telescoping mechanism said rear suspension assembly is attached in a pivotal manner to said central base, and
a front suspension assembly mounted to said central base in a manner to rotate said front suspension assembly at a plurality of differing vertical and horizontal angles with respect to a longitudinal axis of a vehicle, wherein said gear is engaged by another gear which is in turn fixedly coupled to a disc, said disc is held or released by a brake mounted to a support.

14. The system of claim 13 wherein said front suspension assembly further comprises:
a four-arm unit for attaching said front suspension assembly to said center base, said four-arm unit is linked pivotally to said center base on one end and to a front support on the other end in order to permit a vertical displacement of said front suspension assembly with respect to said center base.

15. The system of claim 13 wherein said front suspension assembly further comprises:
an actuator device for commanding and controlling said displacement;
an upper forward suspension bar and a lower forward suspension bar;
a torsional shaft fixed to a front differential base and mounted to said front support with a bearing to permit said assembly to rotate with respect to said longitudinal axis of said chassis:
an axle runs via a center of said torsional shaft and transmits torque from transmission to a front differential; and
a gear fixedly coupled with said torsional shaft to hold said front differential base with respect to a horizontal axis.

16. The system of claim 14 wherein said brake is normally on so as to hold said front suspension assembly level with said center base.

17. The system of claim 14 wherein said brake is disengaged to permit said front suspension assembly to tilt clockwise and counterclockwise and a free spinning tire to make contact with a ground and/or a solid object in order to achieve traction.

18. A central multidirectional transmission system, comprising:
a chassis having a central base and a central multidirectional mechanism;
a rear suspension assembly serving as a base for a rear suspension and a telescoping mechanism said rear suspension assembly is attached in a pivotal manner to said central base, and
a front suspension assembly mounted to said central base in a manner to rotate said front suspension assembly at a plurality of differing vertical and horizontal angles with respect to a longitudinal axis of a vehicle, wherein said front suspension assembly is raised and lowered independently and in conjunction with said rear suspension assembly to achieve a plurality of configurations to overcome an obstacle and to navigate a specific terrain.

19. The system of claim 18 wherein said rear suspension assembly further comprises:
a rear suspension mechanism mounted to said center base to permit said rear suspension assembly to rotate up and down with respect to said center base;
a rear differential base having a telescoping bar slip in and out of said rear suspension mechanism effectively elongating said rear suspension assembly by a protrusion amount.

20. The system of dam 18 wherein said rear suspension assembly further comprises:
a fixed shaft and a plate of said rear suspension mechanism that fits inside a hollow cylinder and is free to rotate axially inside said hollow cylinder;
a gear that spins freely with respect to said shaft and is engaged by a worm mounted to said hollow cylinder; and
a torsion spring that fits inside said hollow cylinder and is attached to a plate at one end and to said gear at other end wherein said gear is turned to tighten and unwrap a plurality of coils of said spring based on a direction of said turn in order to rotate said rear suspension mechanism upward and downward yet maintaining a level of torsional resistance.
